(19) United States
(12) Patent Application Publication
(10) Pub. No.: US 2008/0318605 A1
(43) Pub. Date: Dec. 25, 2008

(54) Zero Power Radio

(76) Inventors: Eric H. J. Persoon, Dommelen (NL); Petrus G.M. Baltus, Valkenswaard (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/630,849

(22) PCT Filed: Jun. 20, 2005
(86) PCT No.: PCT/IB2005/052013

§ 371 Date: Aug. 1, 2008

(30) Foreign Application Priority Data
Jun. 24, 2004 (EP) 04102936.4

(51) Int. Cl. H04B 7/08; H04B 7/00

(52) U.S. Cl. 455/500; 455/132

(57) ABSTRACT

A receiver has a first (12) and a second radio system (14). The first radio system (12) is a zero-power system and the second radio system (14) can either be in an active-state or in an off-state. The first radio system (12) is designed to bring the second radio system (14) from an off-state back into an active state upon receipt of a dedicated radio signal.

The invention relates to a receiver comprising a first and a second radio system and to a radio signal for use with such radio system. The invention also relates to a mobile device using such receiver and to a transmitter for emitting a radio signal that is detectable by the first radio system. The invention further relates a base station comprising such transmitter and to a radio signal and to a method of transmitting such radio signal.

A receiver comprising first and second radio systems, is known from the European Patent EP 1 037 480 B1. Shown is a mobile phone having a secondary system and a main system for the processing of radio electric signals. The main processing system can be in a sleep mode. The secondary system permits the maintenance of reduced activity of reception and of processing of certain radio electric signal during the sleep mode of the main system.

It is an object of the invention to provide an alternative embodiment of the aforementioned receiver. This object is realized in that the receiver comprises a first and a second radio system, the first radio system being a zero-power radio system, the second radio system being either in an active-state or in an off-state, the first radio system being arranged to bring the second radio system from the off-state back into the active state upon receipt of a radio signal.

The invention is based upon the insight that by using a zero-power first radio system for activating a deactivated second radio system, a very power efficient solution is obtained. This obviously will improve the standby time of the receiver. If no relevant signals are received, the second radio system may remain in an off-state during which no power is drawn from a power source. Also the first radio system that activates the second radio system upon request draws no power.

In an embodiment of a receiver according to the invention, the first radio system comprises a zero power crystal radio system. These kinds of radio systems are well known in the art for their low complexibility.

In yet another embodiment of a receiver according to the invention the first radio system comprises a chirp receiver, which offers a better selectivity in case of interferers compared to a crystal radio system.

In another embodiment of a receiver according to the invention, the first radio system comprises a PAM receiver, which also offers better selectivity in case of interferers.

In another embodiment of a receiver according to the invention, the receiver comprises a switch device that is controllable by the first radio system so as to activate the second radio system. This switch device can e.g. be used to couple the power supply through to the second radio system, which is a very convenient way of bringing the second radio system back into an active state.

In another embodiment of the receiver according to the invention, the switch device is a MOS-FET device. This type of transistor can easily be operated by a crystal radio system since the required current for operating the switch device is only equal to a few femto amperes. Therefore, this kind of switch is also virtually zero-power, or at least extremely low power.

In an embodiment of the receiver according to the invention the radio signal comprises a code sequence that is detectable by the first radio system. This way the first radio signal can be instructed by a transmitting device to awaken the second radio system.

In another embodiment of the receiver according to the invention the radio signal is having a predefined frequency that is detectable by the first radio system. This too, is a convenient way to instruct the first radio system to awaken the second radio system.

These and other aspects of the invention will be further elucidated by means of the following drawings.

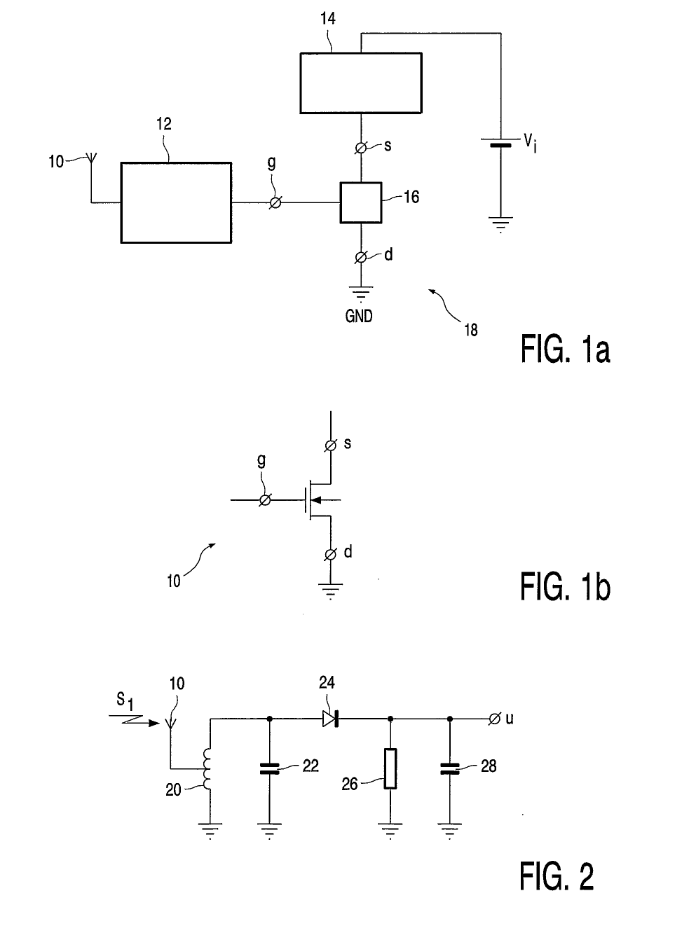

FIG. 1 shows a receiver according to the invention;

FIG. 1b shows a switch device for switching on the main radio of the receiver;

FIG. 2 shows an implementation of the zero power radio using a crystal radio;

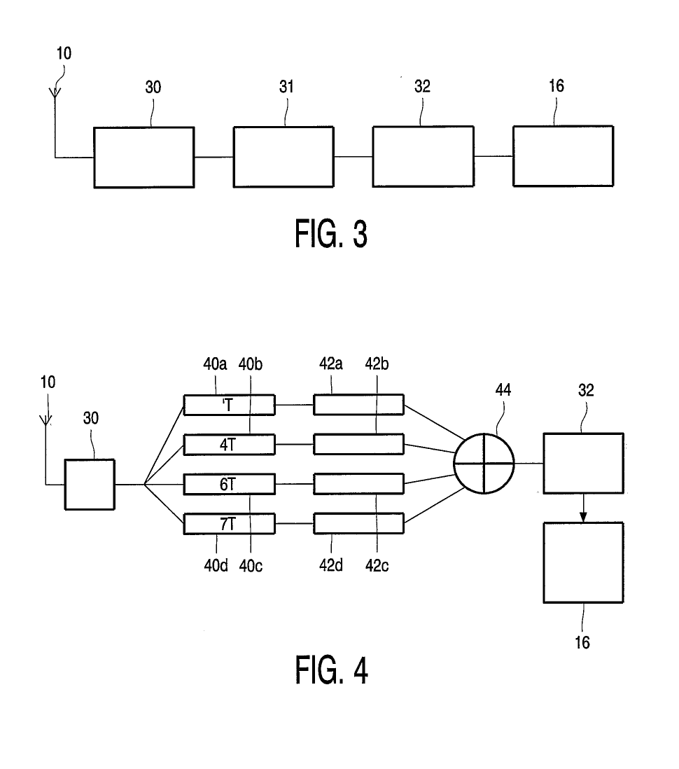

FIG. 3 shows an implementation of the zero power radio using a chirp receiver;

FIG. 4 shows and implementation of the zero power radio using a PAM receiver;

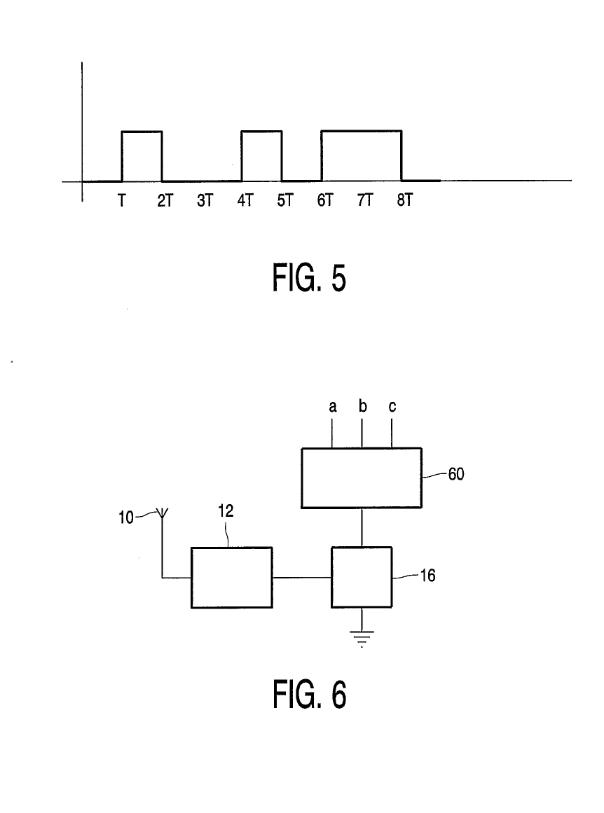

FIG. 5 shows the control signal for use with a PAM receiver;

FIG. 6 shows part of a receiver according to the invention comprising a digital processing device.

Power dissipation is becoming more and more an issue, particularly for systems that were originally designed for environments wherein power dissipation was not really an issue, but are now being used in other environments where power dissipation is becoming a key issue. A typical example is a wireless local area network (WLAN) radio. These were originally intended for use in e.g. laptop computers, but are now also being applied in e.g. cellular phones or PDA's. In such cases the power dissipation of the WLAN radio in standby mode can easily dominate the total power dissipation of the new combined phone or PDA. This is easily demonstrated by the following example. A Philips Xenium GSM phone has a standby time of 400 hours with a 900-mAh battery. A WLAN phone e.g. has a standby time of only 21 hours with a 1400-mAh battery. Adding a WLAN radio to a GSM mobile device or e.g. a PDA would therefore considerably reduce the standby time of the mobile phone or PDA, which is clearly undesirable. Therefore, a receiver according to the invention could help to reduce the power dissipation considerably.

FIG. 1, shows a receiver 18, according to the invention. Shown is a first radio system 13 and a second radio system 14. The second radio system can either be active (active-state) or inactive (off-state). The second radio system can be deactivated, e.g. by decoupling the radio system from its power source Vi. This can be achieved by disconnecting the second radio system 14 from ground level GND. The second radio system can be disconnected from ground trough switch device 16, which can be a MOS-FET (see FIG. 1b), which is almost an ideal, zero power switch device. The output voltage level at terminal g of the zero-power radio is sufficient to operate the switch device 16.

FIG. 2 shows a crystal radio, which is an example of a zero power radio system. There are many implementations of crystal radios known in the art. In the crystal radio according to FIG. 2, the antenna 10 drives the LC tank 20,22. This LC tank 20,22 not only provides the required frequency selectivity for detecting the radio signal s₁ but also transforms the received signal to a higher impedance level (and therefore a higher voltage). The diode 24, detects the peak levels across the LC tank 20,22 and charges capacitor 28 with these peaks. Once the required peak-level is achieved, switch device 16 is closed such that the second radio system is re-activated again. Resistor R1, slowly discharges capacitor 28 to switch of the original radio if no signal s1 is received for a long time.

FIG. 3, shows an implementation of a zero power radio system, which is based on a so-called chirp receiver. The Chirp receiver may comprise RF filter 30 to provide the required frequency selectivity, a Chirp filter 31, a Peak/Signal detector 32 and a switch device 16. A chirp receiver offers a better selectivity in case of interferers. It also allows a specific receiver to be addressed in situations where multiple receivers are near each other. In a chirp receiver, the transmitted signal has a frequency that changes over time. In the receiver a special filter structure 31 is sensitive to exactly one frequency versus time curve. The chirp filters are e.g. used for radar pulse compression see e.g. C. Atzeni, et al., Digital Technology Improves Radar Pulse Compression, Microwaves & RF, pp. 64-70, March 1993. The chirp filter 31 offers a frequency-dependent group delay that matches the frequency-versus-time characteristics of the transmitted signal. Note that in practical implementations, the RF-filter 30 and the “Chirp filter” 31 might be merged into a single filter. The peak/signal detector 32 and the switch device 16 can be implemented in the same way as shown in FIG. 2.

FIG. 3 shows an exemplary implementation of a zero-power radio system using a so-called PAM (Pulse Amplitude Modulation) receiver. The effect of a PAM receiver is the same as a Chirp receiver: in an area with multiple closely spaced receivers, a single receiver can be addressed and switched on. This reduces the unnecessary powering up of receivers that do not need to receive signals at this point in time. In a PAM receiver, the Chirp filter is replaced by a set of delay lines 40a . . . 40d, for delaying the incoming signal by specific amounts according to an individual code of the receiver. The (code) signal that is transmitted to the PAM receiver is a fixed frequency signal which has been amplitude modulated. Typically Amplitude Shift Keying (ASK) is used. An exemplary (code) signal is shown in FIG. 5. The delay lines 40a . . . 40c of FIG. 3, have delays of respectively T, 4T, 6T and 7T which corresponds to the delays of the “high” amplitude bits from the start of the code signal. Therefore, these “high” bits will be added together at the same time (8T) by means of adder 44. Once the signal level exceeds a threshold level of signal level detector 32, switch device 16 is closed to switch on the power of the main receiver. Ideally, the number of timeslots with “high” amplitudes should be the same for each codeword since in this case there only needs to be one threshold value. By means of example, threshold of the signal level detector could be set between 3 and 4 times the “high” level of a single bit to avoid a false (erroneous) reaction of the detector. The exemplary PAM filter also comprises signal detectors 42a . . . 42d, which are amplitude peak detectors.

FIG. 6, shows a part of a receiver according to the invention. Instead of coupling the switch device 16 to the first (main) radio system, it is coupled to a digital processing device 60 which has a low power consumption, and is capable of executing much more complex tasks than ever could be realized by a zero-power radio. An example of an instruction could e.g. be an instruction to switch on only specific parts of the receiver such as WLAN subsystem (not shown here) whilst other parts of the system (e.g. a GSM radio) remain deactivated. Therefore, the digital processing device may comprise control outputs a,b,c for controlling (e.g. switching on) the different parts of the receiver.

This invention is relevant for all low power systems (e.g. mobile devices) that require a radio with a relatively high standby current, such as PDA's of cell phones or cordless phones that are equipped with e.g. WLAN radios or DVB-T radios.

It should be noted that the above-mentioned embodiments illustrate rather than limit the invention, and that those skilled in the art will be able to design many alternative embodiments without departing from the scope of the appended claims. All signal processing shown in the above embodiments can be carried in the analogue domain and the digital domain. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Receiver comprising a first 12 and a second 14 radio system, the first radio system 12 being a zero-power radio system, the second radio system 14 being either in an active-state or in an off-state, the first radio system 12 being arranged to bring the second radio system 14 from the off-state back into the active state upon receipt of a radio signal.

2. Receiver according to claim 1, wherein the first radio system 12 is a zero power crystal radio system.

3. Receiver according to claim 1, wherein the first radio system 12 comprises a chirp receiver.

4. Receiver according to claim 1, wherein the first radio system 12 comprises a PAM receiver.

5. Receiver according to claim 1 comprising a switch device 16 that is controllable by the first radio system so as to activate the second radio system.

6. Receiver according to claim 5, wherein the switch device 16 is MOS-FET device.

7. Receiver according to claim 1, wherein the radio signal comprises a code sequence that is detectable by the first radio system 12.

8. Receiver according to claim 1, wherein the radio signal is a signal having a predefined frequency that is detectable by the first radio system 12.

9. Receiver according to claim 1, wherein the receiver comprises a digital processor 60, for processing the radio signal.

10. Transmitter arranged to transmit a radio signal for use with a receiver according to claim 1, the radio signal being arranged to instruct the first radio system 12 to activate the second radio system 14.

11. Transmitter according to claim 10, wherein the radio signal comprises a code sequence that is detectable by the first radio system.

12. Transmitter according to claim 10, wherein the radio signal is having a frequency that is detectable by the first radio system.

13. Mobile device comprising a receiver according to claim 1.

14. Base station comprising a transmitter according to claim 10.

15. Radio signal for use with a receiver according to claim 1, wherein the radio signal is arranged to instruct the first radio system 12 to activate the second radio system 14.

16. Method of transmitting a radio signal from a transmitter to a receiver comprising the steps of:
constructing a radio signal that is arranged to instruct a first zero power radio system 12 of the receiver to activate a second radio system 14 of the receiver.
transmitting the signal to the receiver.

17. Method according to claim 16, wherein the radio signal comprises a code sequence that is recognizable by the first radio system.

18. Method according to claim 16, wherein the radio signal is having a frequency that is recognizable by the first radio system.
